(19) United States
(12) Patent Application Publication
(10) Pub. No.: US 2016/0272333 A1
(43) Pub. Date: Sep. 22, 2016

(54) AUTONOMOUS AIRBAG SYSTEM FOR UNMANNED AERIAL VEHICLES

(71) Applicant: Sharper Shape Oy, Espoo (FI)

(72) Inventor: Tero Heinonen, Jarvenpaa (FI)

(21) Appl. No.: 14/660,165

(22) Filed: Mar. 17, 2015

Related U.S. Application Data
(60) Provisional application No. 61/972,522, filed on Mar. 31, 2014.

(51) Int. Cl. B64D 25/00; B64C 13/16; B64C 39/02

(52) U.S. Cl. CPC B64D 25/00; B64C 39/024; B64C 13/16; B64D 2201/00

(57) ABSTRACT

The present disclosure is related to an autonomous airbag unit (AAU) for an unmanned aerial vehicle (UAV). The AAU includes a first sensor configured to determine a speed of the UAV, a second sensor configured to determine a relative speed of the UAV in relation to an object with which the UAV is likely to collide, an airbag cushion, an inflator connected to the airbag cushion, and an airbag control unit, connected to the first and second sensors and inflator. The airbag control unit is configured to estimate a momentum of the UAV based on a speed of the UAV, determine if the momentum of the UAV exceeds a threshold momentum value, determine if the relative speed of the UAV in relation to the object exceeds a threshold relative speed, and enable the inflator to inflate the airbag cushion when the momentum and the relative speed exceeds respective threshold limits.

### CROSS-REFERENCE TO RELATED APPLICATIONS

This application claims priority to, and the benefit of, U.S. Provisional Patent Application No. 61/972,522 the disclosure of which is incorporated herein by reference in its entirety.

### TECHNICAL FIELD

The present disclosure relates to flying devices such as Unmanned Aerial Vehicle (UAV), and in particular, to safety features for UAV in case of emergency landing.

### BACKGROUND

Unmanned aircrafts have been generally defined and identified by a number of different titles, for instance, UAV by Joint JAA and Euro control task-force, Unmanned Aircraft Systems (UAS) by European Commission and European Aviation Safety Agency (EASA), Remotely Piloted Aircraft Systems (RPAS) and Remotely Piloted Vehicles (RPV) by most militaries. The Unmanned Aerial System (UAS) may refer to the complete system including UAVs, ground control stations, data links, displays, and controls which together are used to operate the UAV.

Examples of UAVs include, but are not limited to, drones, helicopters, airplanes, and balloons. The UAVs may be classified and categorized according to various ranges/altitudes and sometimes by functional categories. Further, there are a wide variety of shapes, sizes, configurations, weights, speeds, and characteristics of the UAVs. There may be small UAV's that weigh less than kilogram up to large devices with 10000's of kilograms of weights. Further, some of the UAV's may move relatively slowly and others relatively fast.

A typical UAV has a complex arrangement and an error situation therein may lead to uncontrolled or limitedly controlled landing of the UAV. If the UAV, for one reason or other, hits another UAV, a vehicle, a building or a human, it might cause a lot of destruction. A solution to the above-mentioned problem is launching parachutes for UAV in situation of a fatal error. However, the parachutes may result in uncontrolled landing of the UAV to an arbitrary place, and may lead the UAV to collide in midair with other aircraft. In case the emergency landing occurs in areas with people, driving cars, or e.g. nuclear facility, the impact of the UAV may cause death, accident, or even a major disaster.

Airbags are known from automotive industry. They are configured to be launched when the sensors in the cars sense very high deceleration or accelerations. These airbags rely on collision sensors to detect the collision, i.e. the collision has to take place before the airbag is launched. For car collisions, the structure and frame of the car absorbs the energy through deformation, and the time for this absorption is sufficient to launch the airbag. However, in case of UAV, there is no such structure absorbing energy, that would enable an airbag launch triggered by at-the-time-of-collision deceleration. Further, as the weight of the UAV is critical and must be minimized, it is not feasible to create a frame optimized to absorb energy in an UAV.

In light of the foregoing, there is a need for a safety feature for UAV's in case of emergency landing, and which overcomes all the above stated disadvantages and shortcomings.

### BRIEF SUMMARY

The present disclosure provides an autonomous airbag unit (AAU) for an unmanned aerial vehicle (UAV).

In one aspect, embodiments of the present disclosure provide an autonomous airbag unit (AAU) for an unmanned aerial vehicle (UAV) comprising a first sensor configured to determine a speed of the UAV, a second sensor configured to determine a relative speed of the UAV in relation to an object with which the UAV is likely to collide, an airbag cushion, an inflator connected to the airbag cushion and configured to generate gas to inflate the airbag cushion, and an airbag control unit, connected to the first sensor, the second sensor and the inflator. The airbag control unit is configured to estimate a momentum of the UAV based on a mass of the UAV and the speed determined by the first sensor, determine if the momentum of the UAV exceeds a threshold momentum value, determine if the relative speed of the UAV in relation to the object exceeds a threshold relative speed, and enable the inflator to inflate the airbag cushion when the momentum and the relative speed exceed respective threshold limits.

An UAV may contain a number of autonomous airbag units (AAU), such as two, three, four, five, six, seven, eight, nine or ten AAU's. The AAU's can be arranged on different sides of the UAV, preferably in order to protect the most sensitive equipment of the UAV. One autonomous airbag unit may also comprise more than one airbag cushion and more than one inflator. For example, a unit may comprise two, three, four or five airbag cushions. Each of the airbag cushions may be equipped with its own inflator, or one inflator may be connected to more than one airbag cushion.

In an embodiment of the present disclosure, the first sensor is a Global Navigation Satellite System (GNSS) receiver or a Global Positioning System (GPS) receiver. Alternatively or additionally based on an embodiment of the present disclosure the first sensor is an Inertial Measurement Unit (IMU).

In an embodiment of the present disclosure, the second sensor is an ultrasound sensor, a light detection and ranging sensor, an infrared sensor, a laser sensor or a laser distance meter unit.

In an embodiment of the present disclosure, the airbag control unit is further configured to automatically deploy the airbag cushion, due to at least one of: a mechanical failure in the UAV, an electrical failure in the UAV, a communication error, a software error, a remote pilot failure, and a remote pilot intentional act.

In an embodiment of the present disclosure, the airbag control unit is further configured to inflate the airbag cushion when the UAV is about to collide with an object, even if the momentum of the UAV is below the threshold momentum value but the UAV has determined that distance to an object is too small, i.e. below a threshold distance value. This can be used for example in a case where the UAV is stationary but another object is about to collide with it.

In an embodiment of the present disclosure, the airbag control unit is further configured to deflate the airbag cushion after the expiry of a predetermined time period from the collision. In a yet another embodiment, the AAU further comprises at least one of an accelerometer and a pressure sensor.

According to another aspect of the disclosure, it relates to an unmanned aerial vehicle comprising at least one autonomous airbag unit as described above. The UAV may also comprise more than one AAUs, such as two, three, four or five AAU's. In this case, the AAU's are preferably each provided with communication means for interacting with each other.

The present disclosure further relates to a method for controlling an autonomous airbag unit of an unmanned aerial vehicle comprising

determining a speed of the unmanned aerial vehicle with a first sensor;

determining a relative speed of the unmanned aerial vehicle in relation to an object with which the unmanned aerial vehicle is likely to collide, with a second sensor;

estimating a momentum of the unmanned aerial vehicle based on a mass of the unmanned aerial vehicle and the speed determined by the first sensor;

determining if the momentum of the unmanned aerial vehicle exceeds a threshold momentum value;

determining if the relative speed of the unmanned aerial vehicle in relation to the object exceeds a threshold relative speed; and

enabling an inflator to inflate an airbag cushion of the airbag unit when the momentum and the relative speed exceed respective threshold limits.

Embodiments of the present disclosure provide an autonomous airbag system installed in a UAV that is deployed in case of an evident crash or collision. The airbag is deployed before actual physical contact with the object or person with which the UAV is likely to collide.

Additional aspects, advantages, features and objects of the present disclosure would be made apparent from the drawings and the detailed description of the illustrative embodiments.

It will be appreciated that features of the disclosure are susceptible to being combined in various combinations or further improvements without departing from the scope of the disclosure and this provisional application.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is a schematic illustration of an Unmanned Air Vehicle (UAV) including one or more Autonomous Airbag Units (AAUs), in accordance with an embodiment of the present disclosure;

FIG. 2 is a schematic illustration of an autonomous airbag unit (AAU) of FIG. 1, in accordance with an embodiment of the present disclosure;

FIG. 3 is an illustration of contour plots for different momentums for different mass and velocities of the UAV, in accordance with an embodiment of the present disclosure; and

FIG. 4 is a schematic flowchart illustrating steps in accordance with an embodiment of the present disclosure.

### DESCRIPTION OF THE PREFERRED EMBODIMENTS

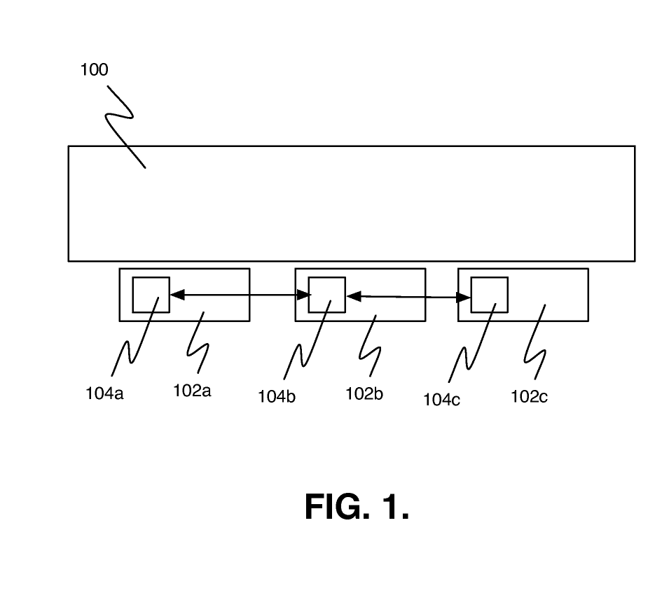

Referring now to the drawings, particularly by their reference numbers, FIG. 1 is an illustration of an unmanned air vehicle (UAV) 100 including here autonomous airbag units (AAU) 102a, 102b and 102c (hereinafter collectively referred to as AAUs 102), in accordance with an embodiment of the present disclosure. The AAUs 102 are safety devices installed at a bottom portion of the UAV 100, for minimizing damage to an object when the bottom portion of the UAV 100 collides with the object. The AAUs 102 includes airbag cushions that are inflated, when the UAV 100 is about to collide with an object in the event of an emergency landing.

In a collision, a force acts upon an object for a given amount of time to change the object's velocity. The product of force (F) and time (t) is referred as impulse (I). The product of mass (m) and velocity change (delta v, Δv) is known as momentum change. In a collision the impulse encountered by an object is equal to the momentum change it experiences:

F·t=m·Δv (2)

In any collision, the momentum p is conserved

m₁v₁+m₂v₂=m₁v′₁+m₂v′₂ (3)

where m₁ and m₂ represent the mass of the objects 1 and 2 and v₁ and v₂ the velocities of the objects before collision and v₁′ and v₂′ velocities of the objects after collision respectively.

If a collision between two objects is inelastic, the objects basically “stick” together after the collision and continue in a certain direction with common speed. On the other hand if the collision is elastic, the objects bounce and continue with different speeds depending on masses of the objects, and in different directions.

In case of inelastic collision, equation (3) can be represented as:

m₁v₁+m₂v₂=v (m1+m2)

Further, the kinetic energy of a colliding object is transferred as kinetic energy of colliding object+object where it collided less heat/transformation related energies related to actual collision

$$\frac{1}{2} {m}_{1} {v}_{1}^{2} = \frac{1}{2} ( {m}_{1} + {m}_{2} ) {v}_{2}^{2} + {E}_{impact} \qquad ( 4 )$$

For safety reasons it is preferable to have an airbag structure for UAV 100 which causes inelastic collision to occur since in inelastic collision, change of speed for the colliding object is smaller than in case of elastic collision. Thus impulse I experienced in the collision is smaller.

In accordance with an embodiment of the present disclosure, the total number of AAUs 102 and their sizes are selected such that entire bottom portion of the UAV 100 is covered in order to reduce the possibility of contact between the UAV 100, and possible object to which the UAV 100 is about to collide. Although the AAUs 102 are shown to be installed at a bottom portion of the UAV 100, it would be obvious to one of ordinary skill in the art, that the AAUs 102 can be installed in any portion of the UAV 100 such as top or sides.

The AAUs 102a, 102b and 102c include communication interfaces 104a, 104b, and 104c respectively, for interacting with each other through one or more communication signals, where the communication interfaces 104a, 104b, and 104c can be wired or wireless. In accordance with another embodiment of the present disclosure, when one or more AAUs 102 make the decision to inflate respective airbag cushions, then they may communicate the same to another AAUs 102. In some cases, the deployment of inflation of airbags by the AAUs 102 is required to be substantially simultaneous. In order to enable the deployment substantially simultaneously, the communication signal may include a countdown timer to indicate time of simultaneous inflation of the airbag cushions.

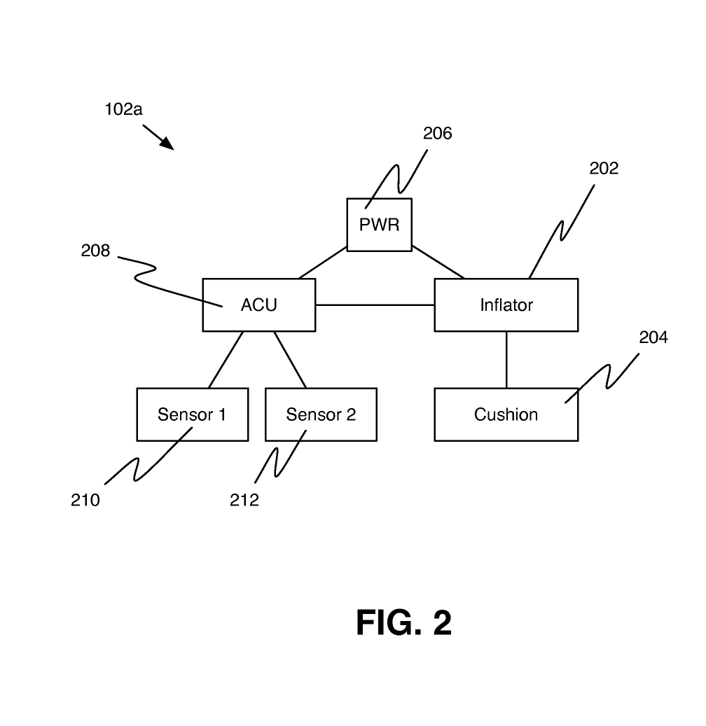

FIG. 2 is an illustration of the Autonomous Airbag Unit (AAU) 102a installed in the UAV 100, in accordance with an embodiment of the present disclosure. The AAU 102a includes an inflator 202, an airbag cushion 204, a power supply (PWR) 206, an airbag control unit (ACU) 208, and first and second sensors 210 and 212. The PWR 206 powers the ACU 208 as well as provides electricity to initialize the inflator 202 and to the first and second sensors 210 and 212. The inflator 202 inflates the airbag cushion 204, based on an output from the ACU 208, which in turn is configured to receive sensor information from the first and second sensors 210 and 212. In an embodiment, the inflator 202 is an inflator system including one or more inflators for generating gas to inflate the airbag cushion 204, where the one or more inflators are deployed based on force and speed required for inflation of the airbag cushion 204. The deployment speed of the airbag cushion 204 is related to the nature of the material and the amount of material used to create gas inside the airbag cushion 204. In an example, sodium azide (NaN₃) and potassium nitrate (KNO₃) are used to create gas inside the airbag cushion 204. As they react, a large pulse of hot nitrogen gas is created instantaneously.

The first and second sensors 210 and 212 are connected to the ACU 208 through a wired or a wireless connection. The first sensor may be at least one of an Inertial Measurement Unit (IMU), a Global Positioning System (GPS) receiver or a Global Navigation Satellite System (GNSS) receiver. The second sensor may be at least one of an ultrasound sensor, a light detection and ranging (Lidar) sensor, an infrared (IR) sensor or a laser distance meter unit. Additionally, the UAV or the AAU may comprise at least one of: an accelerometer and a pressure sensor. The ACU 208 may use the information from
the accelerometer to determine the speed of the UAV 100 and determine possible power failure if the UAV 100 is detected in a free drop stage,
the pressure sensor to determine how fast the UAV 100 is dropping or arising,
the GPS or GNSS receiver to determine speed and direction of the UAV 100,
the Lidar to determine objects underneath or front of the UAV 100
the IR sensor, ultrasound sensors, or laser distance meter to measure distance to objects close to the UAV 100 and their relative speed of approach to the UAV 100.
   Thus, the ACU 208 receives and uses sensor information and pre-programmed information such as mass of the UAV 100 to determine when to a) be prepared to inflate the airbag cushion 204 and b) when to inflate it.

The AAU 102a is preferably configured to not to rely on other systems of the UAV 100, as the AAU 102a needs to work in all cases and circumstances regardless of the condition and operability of other systems of the UAV 100. This is essential as the AAU 102a is a “last resort” safety system which is used when other safety features have failed and the impact of the UAV 100 is imminent.

The AAU 102a is further configured to not to deploy the airbag cushion 204 well in advance before the imminent impact, as it may hinder the aerodynamics and maneuverability of the UAV 100. The UAV 100 (whether copter or fixed wing) is designed aerodynamically, and the deployment of the airbag cushion 204 alone may cause the UAV 100 to lose control and crash.

The AAU 102a is further configured to deploy the airbag cushion 204 at the right time before the impact, in order to maximize the energy absorption and minimize impact I by making collision time t as long as possible. Consequently, according to an embodiment, the AAU 102a is configured to inflate the airbag cushion 204 at the right time, and deflate it within a predefined time period from the impact. If the airbag cushion 204 is not designed to deflate, it absorbs less energy and causes an elastic collision resulting in higher deceleration force to the UAV 100 and the object it is colliding with. This would mean more damage to both the UAV 100 and the collided object.

The AAU 102a can further be configured to operate independently of remote pilot actions, and be triggered when the remote pilot has lost any control link with the UAV 100. The AAU 102a can further be configured to automatically deploy the airbag cushion 204 when the impact is due to any of: a) a mechanical failure in the UAV 100, b) an electrical failure in the UAV 100, c) a communication error in respective UAS, d) a software error in respective UAS, e) a remote pilot failure, f) a remote pilot intentional act, or any other reason.

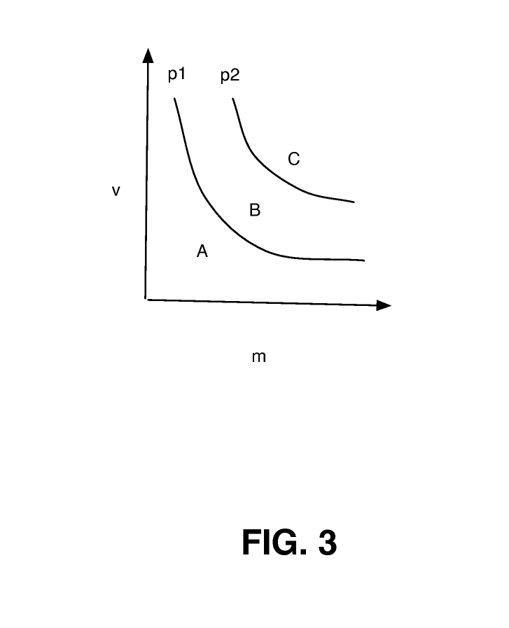

FIG. 3 is an illustration of contour plots 300 for different momentums p1 and p2 for different mass and velocities of the UAV 100, in accordance with an embodiment of the present disclosure. In the contour plots 300, the area A under curve p1 is designated as low momentum area, the area B between curves p1 and p2 as average momentum area, and area C above the curve p2 as high momentum area.

The ACU 102a installed in the UAV 100 receives the velocity information from the first and second sensors 210 and 212, calculates a momentum of the UAV 100 based on a mass of the UAV 100 and the measured velocity, and determines if the momentum of the UAV 100 lies in the area A, B or C at each moment.

Table I represent threshold momentums (kg×m/sec) of the UAV 100 at various masses and speeds. The letters A, B, and C above refer to various momentum areas of the plots 300.

TABLE I

| | m (kg) | | | |
|---|---|---|---|---|
| speed (m/s) | | 5 | 25 | 125 |

| | | | | | | |
|---|---|---|---|---|---|---|
| 1 | 5 | A | 25 | A | 125 | B |
| 10 | 50 | A | 250 | B | 1 250 | C |
| 100 | 500 | C | 2 500 | C | 12 500 | C |

Table II represent motion energy (Joule) of the UAV 100 at various masses and speeds.

TABLE II

| | m (kg) | | | |
|---|---|---|---|---|
| speed (m/s) | | 5 | 25 | 125 |

| | | | | | | |
|---|---|---|---|---|---|---|
| 1 | 3 | [symbol] | 13 | [symbol] | 63 | B |
| 10 | 250 | [symbol] | 1 250 | [symbol] | 6 250 | C |
| 100 | 25 000 | [symbol] | 125 000 | [symbol] | 625 000 | C |

If the measured momentum lies in area A, then the ACU 208 does not initialize the inflator to inflate the airbag cushion 204, since likely damage to objects with low momentum is also low. Also, when the momentum of the UAV 100 lies in the area A, the UAV 100 might be performing its normal maneuvers, for example, making normal landing. However, the ACU 208 may initialize the proximity sensors when the measured momentum is in area A.

Alternatively, if the measured momentum lies in area B or C, the ACU 208 gets ready to inflate the airbag cushion 204. For example, the ACU 208 initializes the proximity sensors such as IR and ultrasonic sensors to measure if the UAV 100 is about to hit an object. The ACU 208 deploys the airbag cushion 204 if the proximity sensors detect an unavoidable collision with a nearby object.

In an embodiment of the present disclosure, based on output from the proximity sensor, the ACU 208 measures the distance between the UAV 100 and a nearby object, and also the relative speed of the UAV 100 with respect to the object. Based on the distance and the relative speed, the ACU 208 calculates a proper timing for inflating the airbag cushion 204. For example, if relative speed between the object and UAV 100 is high, the airbag is launched at a distance d1 from the object. If the relative speed is slower, the airbag is launched at a distance d2<d1 from the object.

In another embodiment of the present disclosure, the ACU 208 controls the force applied to the airbag cushion 204 by selecting the amount of inflators to be used and the number of airbag cushions to be inflated. This can be further enhanced by using inflators in series i.e. launching first one and then second etc. to enable longer impact time compared to launching all at the same time. Longer impact time between the UAV 100 and object reduces impulse thus making the collision less dangerous.

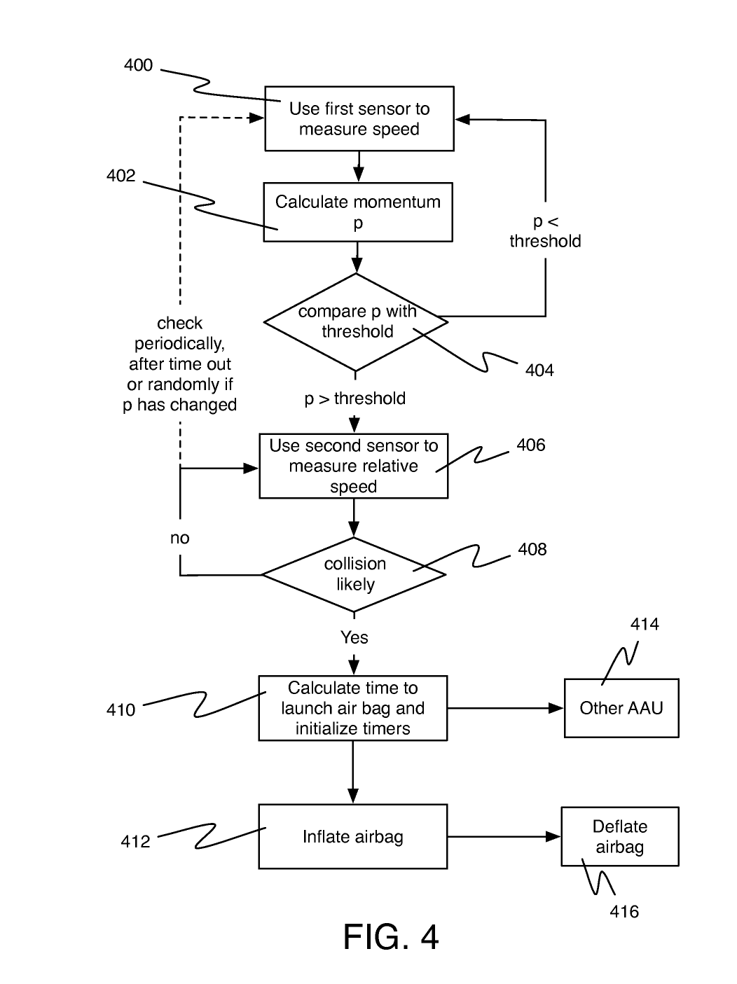

FIG. 4 shows an example flow chart according to an embodiment of the present disclosure. In step 400 a first sensor such as an Inertial Measurement Unit (IMU) is used to measure a speed of the UAV. In step 402 the speed is used to determine a momentum p of the UAV. In step 404 the momentum p is compared with defined thresholds (or alternatively system can be configured to compare speeds only, as a fundamental selection criteria for setting thresholds for speeds is the momentum). If the momentum p is below the threshold, the process is taken back to step 400. If the momentum exceeds the threshold, a second sensor such as IR sensor is used to measure relative speed (step 406). In step 408 collisions' likelihood is analyzed. If there is no likely collision, the relative speed measurement is repeated (step 406). The system is configured to check periodically, continuously, after time out or randomly if there has been a change in the momentum p, i.e. the process goes back to step 400. If based on step 408 the collision is likely, the airbag ignition timers are initialized in step 410. In step 414 other AAU's are provided with timing indication of the first AAU to inflate the airbags. In step 412, at least one airbag is inflated. In a preferred embodiment other airbags of other AAU are inflated substantially at the same time. In step 416 the airbags are deflated. According to additional or alternative embodiments, the deflation time can be controlled.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. An autonomous airbag unit for an unmanned aerial vehicle comprising
a first sensor configured to determine a speed of the unmanned aerial vehicle;
a second sensor configured to determine a relative speed of the unmanned aerial vehicle in relation to an object with which the unmanned aerial vehicle is likely to collide;
an airbag cushion;
an inflator connected to the airbag cushion, and configured to generate gas to inflate the airbag cushion; and
an airbag control unit, connected to the first sensor, the second sensor and the inflator, and configured to:
estimate a momentum of the unmanned aerial vehicle based on a mass of the unmanned aerial vehicle and the speed determined by the first sensor;
determine if the momentum of the unmanned aerial vehicle exceeds a threshold momentum value;
determine if the relative speed of the unmanned aerial vehicle in relation to the object exceeds a threshold relative speed; and
enable the inflator to inflate the airbag cushion when the momentum and the relative speed exceed respective threshold limits.

2. The autonomous air bag unit of claim 1, wherein the first sensor is an inertial measurement unit, a global positioning system receiver or a global navigation satellite system receiver.

3. The autonomous air bag unit of claim 1, wherein the second sensor is an ultrasound sensor, a light detection and ranging sensor, an infrared sensor or a laser distance meter unit.

4. The autonomous air bag unit of claim 1, wherein the airbag control unit is further configured to automatically deploy the airbag cushion, due to at least one of: a mechanical failure in the unmanned aerial vehicle, an electrical failure in the unmanned aerial vehicle, a communication error, a software error, a remote pilot failure, and a remote pilot intentional act.

5. The autonomous air bag unit of claim 1, wherein the airbag control unit is further configured to inflate the airbag cushion when the unmanned aerial vehicle is about to collide with an object, even if the momentum of the unmanned aerial vehicle is below the threshold momentum value.

6. The autonomous air bag unit of claim 1, wherein the airbag control unit is further configured to deflate the airbag cushion after expiry of a predetermined time period from the collision.

7. The autonomous air bag unit of claim 1, further comprising at least one of an accelerometer and a pressure sensor.

8. An unmanned aerial vehicle comprising at least one autonomous airbag unit according to claim 1.

9. The unmanned aerial vehicle of claim 8, comprising at least two autonomous airbag units, each provided with communication means for interacting with each other.

10. A method for controlling an autonomous airbag unit of an unmanned aerial vehicle comprising
determining a speed of the unmanned aerial vehicle with a first sensor;
determining a relative speed of the unmanned aerial vehicle in relation to an object with which the unmanned aerial vehicle is likely to collide, with a second sensor;
estimating a momentum of the unmanned aerial vehicle based on a mass of the unmanned aerial vehicle and the speed determined by the first sensor;
determining if the momentum of the unmanned aerial vehicle exceeds a threshold momentum value;
determining if the relative speed of the unmanned aerial vehicle in relation to the object exceeds a threshold relative speed; and
enabling an inflator to inflate an airbag cushion of the airbag unit when the momentum and the relative speed exceed respective threshold limits.
